(19) United States
(12) Patent Application Publication
(10) Pub. No.: US 2025/0380630 A1
(43) Pub. Date: Dec. 18, 2025

(54) SEED TENDER WITH ASSISTED CONVEYOR POSITIONING AND RELATED METHODS

(71) Applicant: J. & M. Manufacturing Co., Inc., Ft. Recovery, OH (US)

(72) Inventors: Dustan Grieshop, Ft. Recovery, OH (US); Brad Hemmelgarn, Ft. Recovery, OH (US)

(21) Appl. No.: 19/061,023

(22) Filed: Feb. 24, 2025

Related U.S. Application Data
(60) Provisional application No. 63/557,755, filed on Feb. 26, 2024.
(60) Provisional application No. 63/659,471, filed on Jun. 13, 2024.

(51) Int. Cl. A01C 15/00

(52) U.S. Cl. CPC A01C 15/003

(57) ABSTRACT

A seed tender includes a supplying container configured to hold seed, a transfer element, a sensor system, and an actuator configured to control the movement of the transfer element. The transfer element is configured to transfer the seed from the supplying container to a receiving container and includes a conveyor and a discharge spout coupled to the conveyor. The discharge spout is configured to direct the seed into the receiving container. The sensor system is associated with the discharge spout. Moving at least a portion of the discharge spout in a first direction activates the sensor system thereby energizing the actuator which moves the transfer element in a first corresponding direction associated with the first direction.

### CROSS REFERENCE TO RELATED APPLICATION

This application claims the priority of U.S. Provisional Patent Application Ser. No. 63/557,755, filed on Feb. 26, 2024 (pending), and U.S. Provisional Patent Application Ser. No. 63/659,471 filed on Jun. 13, 2024 (pending), the disclosures of which are incorporated herein by reference in their entirety.

This application is also generally related to the subject matter disclosed in U.S. patent application Ser. No. 19/009,352, filed on Jan. 3, 2025, the disclosure of which is incorporated herein by reference in its entirety.

### TECHNICAL FIELD

Embodiments relate generally to agricultural equipment, and specifically to the control of conveyors and conveyor spouts such as those found on seed tenders, and related methods.

### BACKGROUND

Vehicles for receiving and delivering seeds are commonly referred to as seed tenders and include a container having one or more open top bins for receiving a type of seed or different types of seed and for delivering the seed to an agricultural seed planter. Commonly, the seed tender includes an elongated conveyor which can be positioned for receiving the seeds from each bin of the seed tender and elevating and delivering the seeds to seed hoppers on the planter.

Conventional methods for controlling an actuated seed tender conveyor include using a handheld control device, either hardwired or wireless, equipped with toggle switches and/or buttons to control the movement and operation of the conveyor. When loading seeds into the seed hoppers of a box planter, for example, it is necessary to traverse the planter with the conveyor to fill the seed hoppers. An operator of the seed tender will use the handheld control device to control the actuated movement of the conveyor to position a conveyor spout over each of the seed hoppers to fill each seed hopper. Similarly, an operator of the seed tender may use the handheld control device to control the actuated movement of the conveyor to position a conveyor spout over each of the elongated tanks of a drill type planter or the seed tanks of a center fill planter. Continuous actuated movement of the conveyor may not allow for the required conveyor spout residence time over each seed hopper to fill each seed hopper. In most instances, the operator must repetitively use the handheld control device to engage and disengage the actuated movement of the conveyor to position the conveyor spout at a desired fill location, at a desired time, and for a desired period. To avoid seed spillage between seed hoppers, after the conveyor spout is positioned over a seed hopper, the operator uses the handheld control device to turn the conveyor on to fill the seed hopper. When the seed hopper is filled to the desired level or volume, the operator uses the handheld control device to turn the conveyor off.

At least one of the operator's hands is required to position the conveyor spout over each seed hopper, leaving the other hand to operate the handheld control device. With only a single hand available for operation of the handheld control device, the operator will usually use their thumb to control the movement of the conveyor and to turn the conveyor on and off. This usually requires the operator to engage multiple switches and/or buttons on the handheld control device to control the various operations. Use of the handheld control device can be cumbersome and may require the operator to take their eyes off the equipment to ensure the correct switch or button is being actuated. Taking their eyes off the equipment can be both time-consuming and potentially dangerous for the operator or others near the equipment. However, actuating the wrong switch or button may cause a seed hopper to be overfilled, cause seed to be spilled on the ground, or present safety risks due to the inadvertent actuated movement of the conveyor. Actuating the wrong switch or button may also accidentally activate other seed tender features or functions.

Accordingly, and despite the various advances already made in this field, there is a need for further improvements related to the control of conveyors and conveyor spouts, and specifically the control of seed tender conveyors and conveyor spouts.

### SUMMARY

Generally a seed tender is provided. The seed tender includes a supplying container configured to hold seed, a transfer element, a sensor system, and an actuator configured to control the movement of the transfer element. The transfer element is configured to transfer the seed from the supplying container to a receiving container. The transfer element includes a conveyor including a conveyor discharge end portion, and a discharge spout coupled to the conveyor discharge end portion. The discharge spout is configured to direct the seed into the receiving container. The sensor system is associated with the discharge spout. Moving at least a portion of the discharge spout in a first direction activates the sensor system thereby energizing the actuator which moves the transfer element in a first corresponding direction associated with the first direction.

In some embodiments, the sensor system may be deactivated when the discharge spout is in a neutral orientation. The seed tender may include a fail-safe switch. The actuator may only be energized when the fail-safe switch is activated. The seed tender may include an electronic control unit configured to receive a signal from the sensor system. The electronic control unit may energize the actuator based at least in part on the signal from the sensor system. The sensor system may include at least one of a switch, a tilt sensor, or an inclinometer. Moving at least a portion of the discharge spout in a second direction may activate the sensor system thereby energizing the actuator which moves the transfer element in a second corresponding direction associated with the second direction. The discharge spout may include a flexible portion and moving at least a portion of the discharge spout in the first direction or the second direction may cause the flexible portion to bend.

In alternative embodiments, the actuator may be a first actuator, and the seed tender may include a second actuator configured to control the movement of the transfer element. Moving at least a portion of the discharge spout in a third direction may activate the sensor system thereby energizing the second actuator which may move the transfer element in a third corresponding direction associated with the third direction. Moving at least a portion of the discharge spout in a fourth direction may activate the second sensor thereby energizing the second actuator which may move the transfer element in a fourth corresponding direction associated with the fourth direction. The seed tender may include a first switch and a second switch. Activating the first switch may energize the second actuator which may move the transfer element in a third direction. Activating the second switch may energizes the second actuator which may move the transfer element in a fourth direction.

In alternative or additional aspects, moving at least a portion of the discharge spout in the first direction into a first orientation may activate the sensor system thereby energizing the actuator which may move the transfer element in the first corresponding direction at a first velocity. Moving at least a portion of the discharge spout in the first direction into a second orientation may activate the sensor system thereby energizing the actuator which may move the transfer element in the first corresponding direction at a second velocity. The second velocity may be greater than the first velocity. Moving at least a portion of the discharge spout in the second direction into a third orientation may activate the sensor system thereby energizing the actuator which may move the transfer element in the second corresponding direction at the first velocity. Moving at least a portion of the discharge spout in the second direction into a fourth orientation may activate the sensor system thereby energizing the actuator which may move the transfer element in the second corresponding direction at the second velocity.

Generally, an alternative seed tender is provided. The alternative seed tender includes a supplying container configured to hold seed, a transfer element, a sensor system, a fail-safe switch, an actuator, and an electronic control unit. The transfer element is configured to transfer the seed from the supplying container to a receiving container. The transfer element includes a conveyor including a conveyor discharge end portion, and a discharge spout coupled to the conveyor discharge end portion. The discharge spout is configured to direct the seed into the receiving container. The sensor system is associated with the discharge spout. The actuator is configured to control the movement of the transfer element. The electronic control unit is configured to receive a signal from the sensor system and to energize the actuator based at least in part on the signal from the sensor system. The actuator can only be energized when the fail-safe switch is activated. Moving at least a portion of the discharge spout in a first direction activates the sensor system thereby energizing the actuator which moves the transfer element in a first corresponding direction associated with the first direction. Moving at least a portion of the discharge spout in a second direction activates the sensor system thereby energizing the actuator which moves the transfer element in a second corresponding direction associated with the second direction. The sensor system is deactivated when the discharge spout is in a neutral orientation.

The discharge spout may include a flexible portion and moving at least a portion of the discharge spout in the first direction and the second direction may cause the flexible portion to bend. The sensor system may include at least one of a switch, a tilt sensor, or an inclinometer.

In alternative embodiments, the actuator may be a first actuator, and the seed tender may include a second actuator configured to control the movement of the transfer element. Moving at least a portion of the discharge spout in a third direction may activate the sensor system thereby energizing the second actuator which may move the transfer element in a third corresponding direction associated with the third direction. Moving at least a portion of the discharge spout in a fourth direction may activate the second sensor thereby energizing the second actuator which may move the transfer element in a fourth corresponding direction associated with the fourth direction. The seed tender may include a first switch and a second switch. Activating the first switch may energize the second actuator which may move the transfer element in a third direction. Activating the second switch may energizes the second actuator which may move the transfer element in a fourth direction.

In alternative or additional aspects, moving at least a portion of the discharge spout in the first direction into a first orientation may activate the sensor system thereby energizing the actuator which may move the transfer element in the first corresponding direction at a first velocity. Moving at least a portion of the discharge spout in the first direction into a second orientation may activate the sensor system thereby energizing the actuator which may move the transfer element in the first corresponding direction at a second velocity. The second velocity may be greater than the first velocity. Moving at least a portion of the discharge spout in the second direction into a third orientation may activate the sensor system thereby energizing the actuator which may move the transfer element in the second corresponding direction at the first velocity. Moving at least a portion of the discharge spout in the second direction into a fourth orientation may activate the sensor system thereby energizing the actuator which may move the transfer element in the second corresponding direction at the second velocity.

Generally, a method for transferring seed from a seed tender to a receiving container is provided. The seed tender includes a supplying container and a transfer element. The transfer element includes a discharge spout and is configured to transfer the seed from the supplying container to the receiving container. The method includes detecting movement of at least a portion of the discharge spout in a first direction. The method includes energizing an actuator based at least in part on the detected movement of the discharge spout in the first direction to move the transfer element in a first corresponding direction associated with the first direction.

In some embodiments, the method may include deenergizing the actuator when the discharge spout is in a neutral orientation. The method may include energizing the actuator only when a fail-safe switch is activated. The method may include detecting movement of at least a portion of the discharge spout in a second direction. The method may include energizing the actuator based at least in part on the detected movement of the discharge spout in the second direction to move the transfer element in a second corresponding direction associated with the second direction. The actuator may be a first actuator. The method may include detecting movement of at least a portion of the discharge spout in a third direction. The method may include energizing a second actuator based at least in part on the detected movement of the discharge spout in the third direction to move the transfer element in a third corresponding direction associated with the third direction. The method may include detecting movement of at least a portion of the discharge spout in a fourth direction. The method may include energizing the second actuator based at least in part on the detected movement of the discharge spout in the fourth direction to move the transfer element in a fourth corresponding direction associated with the fourth direction. The method may include detecting a first switch activation. The method may include energizing a second actuator based at least in part on the detected switch activation to move the transfer element in a third direction. The method may include detecting a second switch activation. The method may include energizing the second actuator based at least in part on the detected switch activation to move the transfer element in a fourth direction.

In alternative embodiments, the method may include detecting at least a portion of the discharge spout in a first orientation and energizing the actuator based at least in part on the detected portion of the discharge spout in the first orientation to move the transfer element in the first corresponding direction at a first velocity. The method may include detecting at least a portion of the discharge spout in a second orientation and energizing the actuator based at least in part on the detected portion of the discharge spout in the second orientation to move the transfer element in the first corresponding direction at a second velocity. The method may include detecting at least a portion of the discharge spout in a third orientation and energizing the actuator based at least in part on the detected portion of the discharge spout in the third orientation to move the transfer element in the second corresponding direction at the first velocity. The method may include detecting at least a portion of the discharge spout in a fourth orientation and energizing the actuator based at least in part on the detected portion of the discharge spout in the fourth orientation to move the transfer element in the second corresponding direction at the second velocity. The second velocity may be greater than the first velocity.

Additional aspects and advantages of the invention will become more apparent upon further review of the detailed description of the illustrative embodiments taken in conjunction with the accompanying drawings.

### BRIEF DESCRIPTION OF THE DRAWINGS

FIGS. 1, 2, and 3 are perspective views of an illustrative seed tender.

FIGS. 4, 5A, 5B, 6A, and 6B are side elevation views of the seed tender FIGS. 1, 2, and 3.

FIG. 7 is a rear perspective view of the seed tender of FIGS. 1, 2, and 3.

FIG. 8 is a detailed view of a discharge spout of the seed tender of FIGS. 1, 2, and 3.

FIG. 8A is a perspective view of an illustrative electronic control device.

FIGS. 9, 10, and 11 are perspective views of portions of a swing arm of the seed tender of FIGS. 1, 2, and 3.

FIG. 12 is a schematic of an illustrative seed tender control system.

FIG. 13 is a simplified schematic of an illustrative hydraulic system.

FIG. 14 illustrates control curves that may be used in conjunction with a proportional hydraulic position valve.

FIGS. 15, 16, and 17 are perspective views of an alternative illustrative seed tender.

FIGS. 18 and 19 are detailed views of a lower portion of a container and inlet end of a transfer element of the seed tender of FIGS. 15, 16, and 17.

### DETAILED DESCRIPTION OF THE ILLUSTRATIVE EMBODIMENTS

The present disclosure is directed to an improved conveyor positioning system configured for positioning a conveyor to receive and deliver agricultural seeds or other granular material. The system includes a conveyor and actuated support system allowing the conveyor to be easily maneuvered into various positions including a position for transferring material from a supplying container to a receiving container. The conveyor may be mounted to an agricultural implement, such as a seed tender for example, and configured to be positioned to transfer agricultural seeds into a hopper, a receiving container, of the seed tender during a self-filling operation. The conveyor may also be configured to be positioned to transfer agricultural seeds from the seed tender hopper, the supplying container, to another agricultural implement, such as a planter. The system allows an operator to readily reposition the conveyor to precisely direct material into a plurality of receiving containers. In one embodiment, the system is configured to allow an operator to direct agricultural seed from a seed tender hopper, the supplying container, into the one or more seed bins, tanks, or hoppers, the receiving containers, of a seed planter.

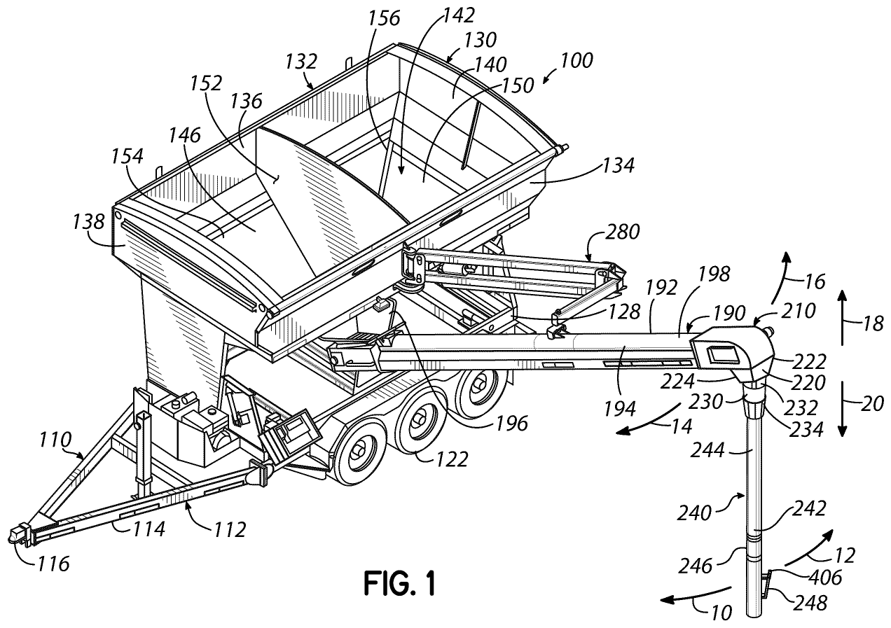

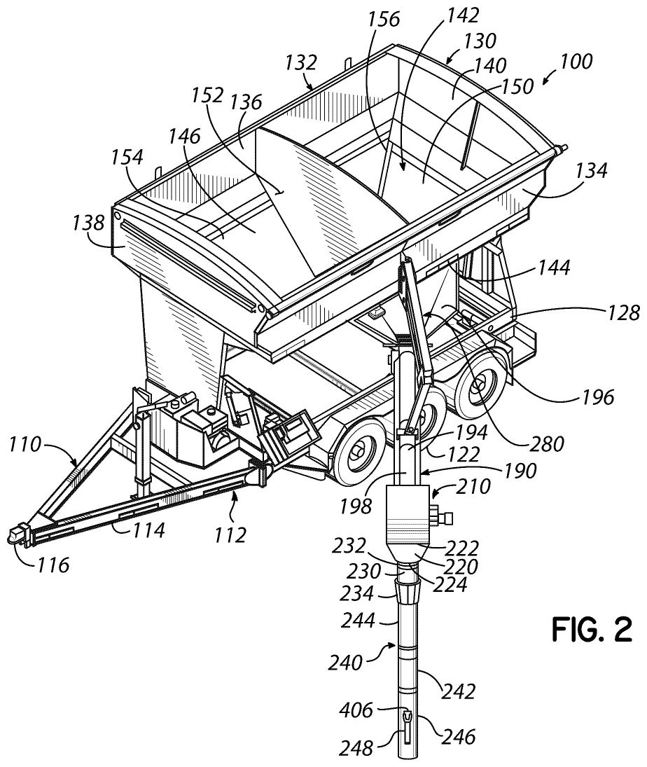

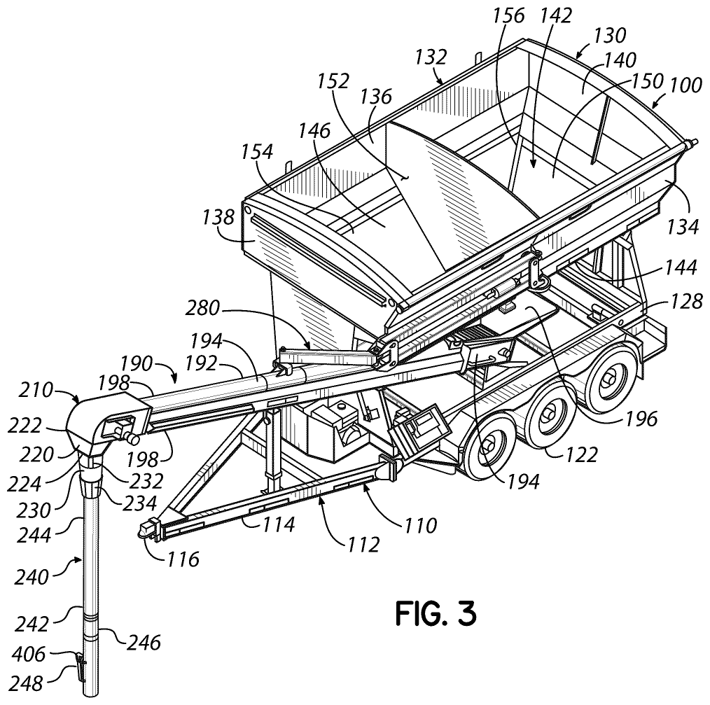

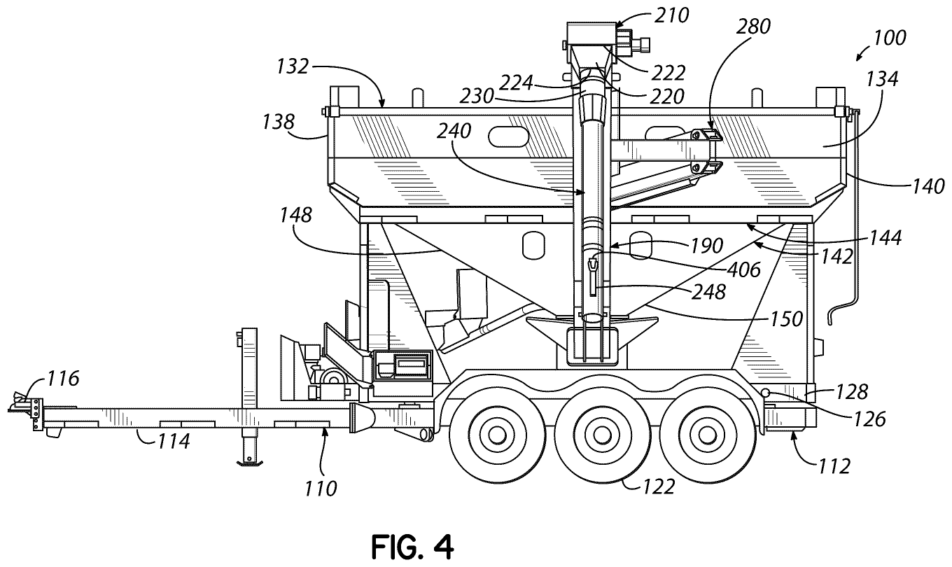

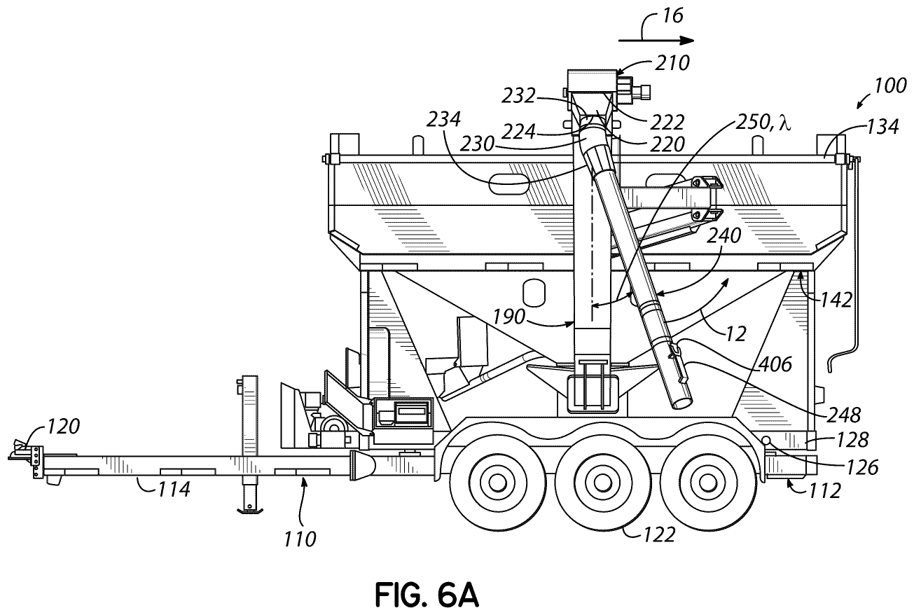

FIGS. 1, 2, and 3 are perspective views of an illustrative seed tender 100. FIGS. 4, 5A, 5B, 6A, and 6B are side elevation views of the seed tender 100. FIG. 7 is a rear perspective view of the seed tender 100. Referring to FIGS. 1 and 4, in this illustrative embodiment, the seed tender 100 includes a chassis 110, a container 130, a transfer element 190, and a swing arm 280. The chassis 110 includes a frame 112 having longitudinally extending frame members converging to form a tongue 114 having a hitch 116 at the front of the frame 112. The hitch 116 is configured to be pivotally connected to a tow vehicle, such as a tractor. The chassis 110 includes one or more pairs of wheels 122 or tracks supporting the frame 112 off of the ground and configured for traversing the ground. When the seed tender 100 is connected to a tow vehicle, the wheels 122 or tracks allow the seed tender 100 to be moved and positioned to receive, unload, or transfer seed or other agricultural materials. A set of load cells 126 are mounted to the top of the chassis 110. A container support frame 128 is mounted to and supported by the load cells 126.

Referring again to FIGS. 1 and 4, in this illustrative embodiment, the container 130 is a hopper fabricated from sheet metal which is mounted on and supported by the container support frame 128 and configured to hold seed or other agricultural materials. The container 130 includes an open top and generally rectangular upper portion 132. The upper portion 132 includes opposed upper left and right side walls 134, 136 connected by an upper front wall 138 and an upper rear wall 140. In this illustrative example, the upper left and right side walls 134, 136 are connected to the upper front and rear walls 138, 140 by square corners. In other embodiments, the upper left and right side walls 134, 136 may be connected to the upper front and rear walls 138, 140 by radiused or angled corners. The container 130 also includes a sloped lower portion 142 including sloped lower left and right side walls 144, 146 connected by a sloped lower front wall 148 and a sloped lower rear wall 150. In this illustrative example, the lower left and right side walls 144, 146 are connected to the lower front and rear walls 148, 150 by square corners. In other embodiments, the lower left and right side walls 144, 146 may be connected to the lower front and rear walls 148, 150 by radiused or angled corners. The upper left and right side walls 134, 136 are respectively coupled to the lower left and right side walls 144, 146. The upper front and rear walls 138, 140 are respectively coupled to the lower front and rear walls 148, 150.

Referring to FIGS. 1 and 7, the container 130 also has a dividing wall 152 which is secured to the upper left and right side walls 134, 136 and the sloped lower left and right side walls 144, 146 to define a front seed chamber 154 and a rear seed chamber 156. Multiple seed chambers 154, 156 enable the container 130 to receive and keep separate different types of seeds or other agricultural materials. In some embodiments, the container 130 may include additional dividing walls to define additional seed receiving chambers, allowing for additional types of seeds to be received and delivered. The sloped lower portion 142 guides the seed, or other agricultural materials, to the bottom of the seed chambers 154, 156 for transferring the seed via the transfer element 190. The front and rear seed chambers 154, 156 have respective front and rear bottom discharge outlets which may be selectively opened and closed by respective front and rear sliding gates 162, 164. The front and rear gates 162, 164 are selectively opened and closed by respective front and rear gate actuators 166, 168. The gate actuators 166, 168 are described herein as hydraulic actuators or hydraulic cylinders but may be other types of actuators such as linear actuators, for example.

Referring to FIG. 1, in this illustrative embodiment, transfer element 190 includes a conveyor 192 and a discharge spout 210. The conveyor 192 includes an elongated tubular conveyor housing 194 enclosing a conveying member, such as a motor operated conveyor belt for conveying seed through the tubular housing 194. Other forms of conveyors may also be used, such as, an auger conveyor in a round housing or a conveyor belt with longitudinally spaced slats for holding the seed in place on the conveyor belt within a rectangular housing, for example. The conveyor 192 has a hopper 196 at the receiving end portion of the tubular housing 194 and the discharge spout 210 is mounted at the discharge end 198 of the tubular housing 194.

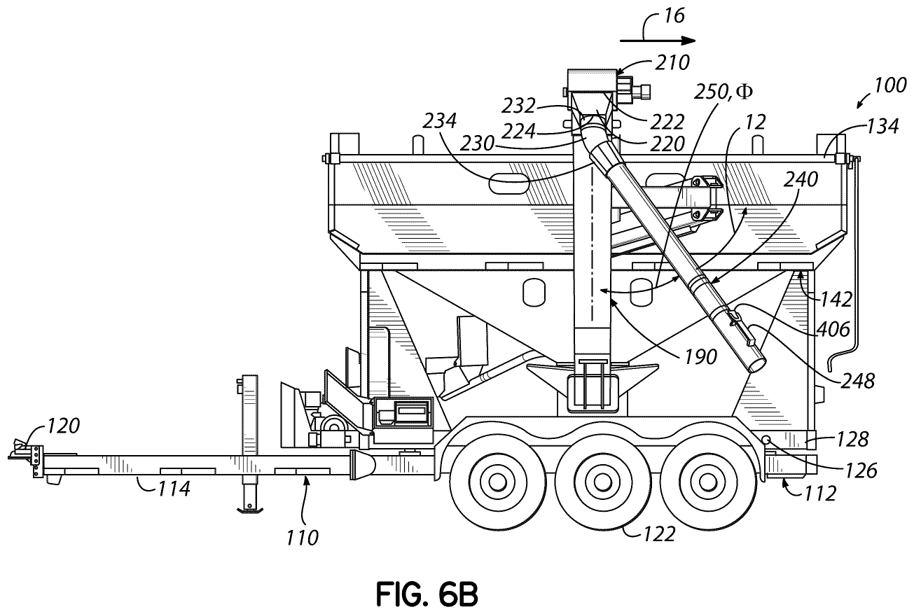

FIG. 8 is a detailed view of discharge spout 210 which includes a transition portion 220, a steerable or flexible portion 230, and a discharge portion 240. The transition portion 220 acts as a funnel, with an inlet 222 configured to catch and direct the material from the discharge end portion of the conveyor 192 to an outlet 224 of the transition portion 220. The inlet 232 of the steerable or flexible portion 230 is coupled via a quick disconnect coupling to the outlet 224 of the transition portion 220. The quick disconnect coupling may be a toolless band clamp. The flexible portion 230 may be uncoupled from the transition portion 220 for various operations, such as a self-filling operation, for example. In this illustrative embodiment, the steerable or flexible portion 230 is a wire reinforced hose. In other embodiments, the steerable or flexible portion 230 may be any configuration that allows for the movement of the discharge portion 240 relative to the transition portion 220. In this illustrative embodiment, the discharge portion 240 includes an extendable portion or telescoping element 242. The telescoping element 242 includes an upper telescoping portion 244 coupled to the outlet 234 of the steerable or flexible portion 230, and a lower telescoping portion 246 slidably coupled to the outer diameter of the upper telescoping portion 244. In this illustrative embodiment, the telescoping portions 244, 246 are polymer tubes and the lower telescoping portion 246 is slip fit over the upper telescoping portion 244. The discharge portion 240 may include one or more handles 248 configured to allow an operator to move or position at least a portion of the discharge spout 210, such as the lower telescoping portion 246, for example. In some embodiments, the telescoping portions 244, 246 may be keyed or have a cross section, such as an oval cross section for example, to prevent the lower telescoping portion 246 from rotating with respect to the upper telescoping portion 244. Preventing rotation of the telescoping portions 244, 246 maintains the orientation of the lower telescoping portion 246 and handle 248 relative to the upper telescoping portion 244.

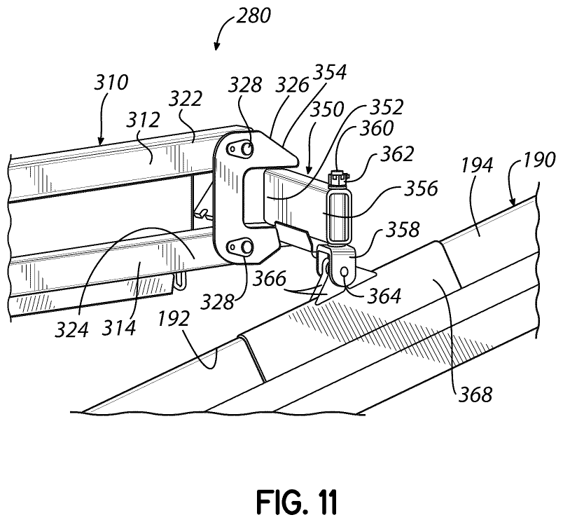

The discharge spout 210 includes one or more sensors and/or switches that are activated when an operator moves at least a portion of the discharge spout 210. In this illustrative embodiment, the discharge spout 210 includes an inclination or tilt sensor 260, such as an inclinometer, mounted on or coupled to the steerable or flexible portion 230 and/or the discharge portion 240. The sensor 260 is configured to detect when the discharge portion 240 moves relative to the transition portion 220. A inclinometer is a device designed to measure the angle of incline or tilt with respect to the force of gravity, detecting a change in orientation of the sensor and providing feedback in the form of an analog signal. The sensor 260 is electrically coupled to the electronic control unit 404, see FIG. 12, by a sensor wire 270 which has a quick disconnect coupling 272 that is disconnected when the flexible portion 230 is uncoupled from the transition portion 220. When activated, the sensor 260 transmits an analog signal to an electronic control unit 404. In other embodiments, the sensor 260 may be mounted on or coupled to other portions of the discharge spout 210. In some embodiments, the discharge spout 210 may have multiple sensors 260. The sensor 260 may be any sensor configured to detect when the discharge portion 240 moves relative to the transition portion 220. In alternative embodiments, the discharge spout 210 may include one or more switches 262, 264 mounted on or coupled to the steerable or flexible portion 230 and/or the discharge portion 240. The switches 262, 264 may be used instead of or in addition to the sensor 260. The switches 262, 264 may be configured to be activated when the discharge portion 240 moves relative to the transition portion 220. The switches 262, 264 may alternatively be mounted on or coupled to other portions of the discharge spout 210.

FIG. 8A is a perspective view of an illustrative electronic control device. The discharge spout 210 may include one or more controls and/or switches that an operator may use to control various features of the seed tender 100. In this illustrative embodiment, an electronic control device 406, including push buttons 406a, 406b, 406c, 406d, is received into a holder 252 in the handle 248 so the operator may operate the electronic control device 406 while holding the handle. The electronic control device 406 may be a battery powered wireless device. The electronic control device 406 may be removable or may be permanently attached to the handle 248 or other portions of the discharge spout 210. The electronic control device 406 may be configured to enable an operator to control the vertical movement of the discharge spout 210. In some embodiments, the electronic control device 406 may be configured to enable an operator to control the horizontal movement of the discharge spout 210 wherein the electronic control device 406 may be used instead of or in addition to the sensor 260. In some embodiments, the electronic control device 406 may include one or more sensors, such as an inclination or tilt sensor 260′, that are activated when an operator moves at least a portion of the discharge portion 240 of the discharge spout 210. The sensor 260′ is configured to detect when the discharge portion 240 moves relative to the transition portion 220. When the electronic control device 406 is in the holder 252, moving the discharge portion 240 activates the sensor 260′ which, through the electronic control device 406, sends a signal, such as an analog signal, to the electronic control unit 404, see FIG. 12. To conserve the battery power of the electronic control device 406 and prevent unintentional movement of the discharge spout 210, the electronic control device 406 may be configured to only send a signal to the electronic control unit 404 when a fail-safe switch 410 is activated, see FIG. 12. In some embodiments, the electronic control device 406 may include a fail-safe switch. In some embodiments, the fail-safe switch may be one of the push buttons 406a, 406b, 406c, 406d, for example. The holder 252 and/or the electronic control device 406 may include sensors and/or switches, such as a Radio Frequency Identification (RFID) sensor, to disable the sensor 260′ when the electronic control device 406 is not in the holder 252. In alternative embodiments, one or more switches 266, 268 may be mounted on or near the handle 248 so the operator may activate the switches while holding the handle 248. In some embodiments, the switches 266, 268 may be incorporated into a control unit and/or a joystick control, for example.

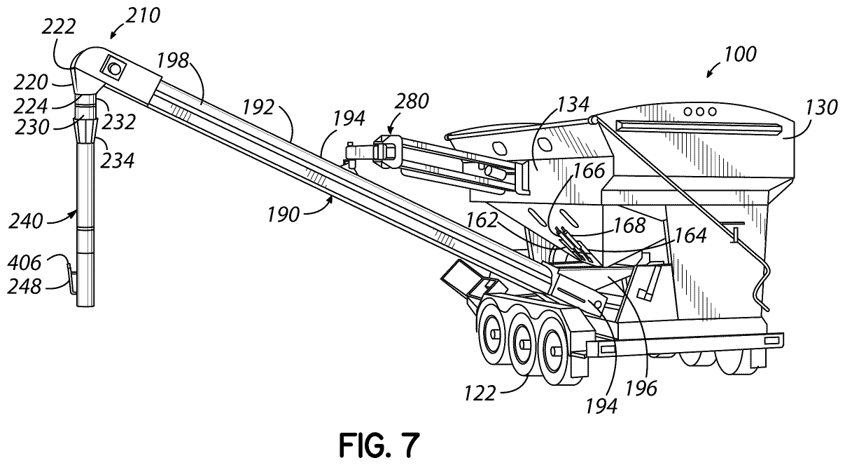

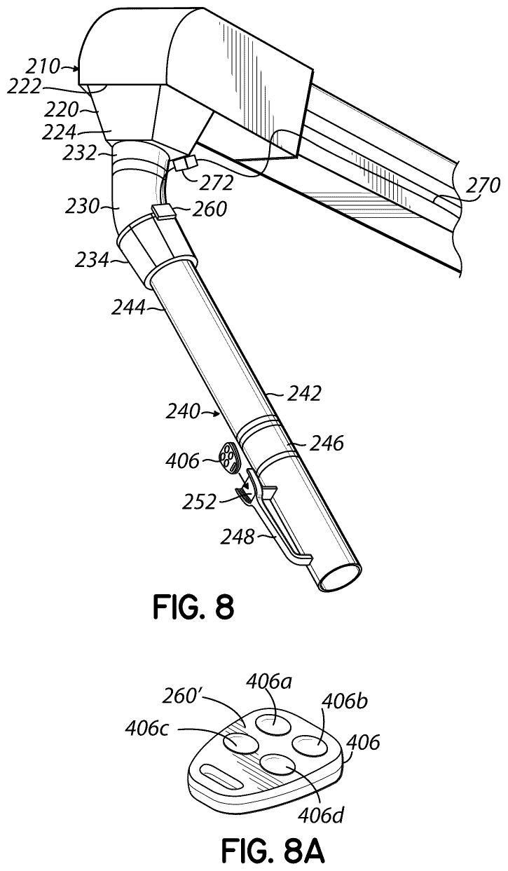

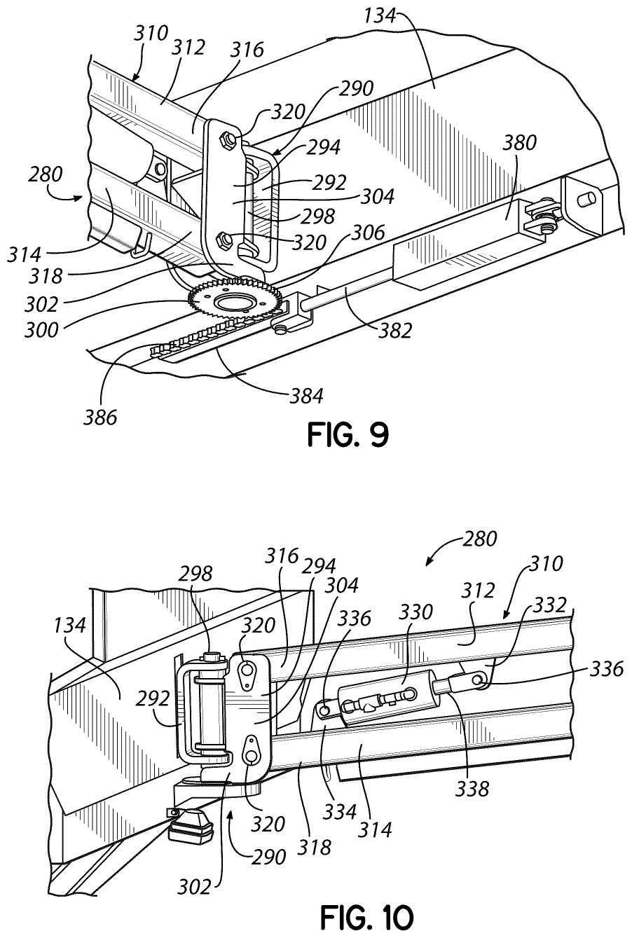

FIGS. 9, 10, and 11 are perspective views of portions of the swing arm 280. The transfer element 190 is supported off the side of the container 130 by the swing arm 280. The swing arm 280 includes a support bracket assembly 290, a lift arm assembly 310, and a swivel arm 350. The support bracket assembly 290 includes a fixed bracket 292 secured to the upper left side wall 134 of the container 130 and generally aligned with the dividing wall 152, see FIG. 1, separating the front and rear chambers 154, 156. A vertical pin or shaft 298 rotatably couples a rotating bracket 294 to the fixed bracket 292. A sprocket 300 is coupled to a bottom portion 302 of the rotating bracket 294.

The lift arm assembly 310 includes parallel spaced upper and lower support arms 312, 314 having respective inner end portions 316, 318, pivotally connected to a U-shaped portion 304 of the rotating bracket 294 by a pair of pivot pins or bolts 320. The support arms 312, 314 have outer end portions 322, 324 pivotally connected to a C-shaped end bracket 326 by a pair of pivot pins or bolts 328. A lift arm actuator 330, such as a hydraulic actuator or hydraulic cylinder for example, is pivotally connected with pins or bolts 336 to a flange 332 coupled to the upper support arm 312 and a flange 334 connected to the lower support arm 314. The lift arm actuator 330 is described herein as a hydraulic cylinder but may be other types of actuators such as a linear actuator, for example. The parallel support arms 312, 314 are configured for vertical rotational movement around the pivot pins or bolts 320 in a vertical plane. The support arms 312, 314 remain parallel as they pivot on the pivot pins or bolts 320, 328. Extension of the rod 338 of the lift arm actuator 330 moves the outer end portions 322, 324 of the support arms 312, 314 and the end bracket 326 vertically upward. Retraction of the rod 338 of the lift arm actuator 330 moves the outer end portions 322, 324 of the support arms 312, 314 and the end bracket 326 vertically downward. Due to the parallel movement of the support arms 312, 314, the orientation of the end bracket 326 is maintained while the end bracket 326 moves up and down.

The swivel arm 350 has an inner end portion 352 rotatably connected to the end bracket 326 by a vertical pin or shaft 354. The swivel arm 350 is free to rotate or swing in a horizontal plane around the central axis of the pin or shaft 354. A U-shaped bracket or clevis 358 is supported by a pin 360 and nut 362 from the outer end portion 356 of the swivel arm 350. The clevis 358 is connected by a pin 364 to a pair of flanges 366 secured to a curved reinforcing plate 368 attached to the tubular housing 194 of the conveyor 192. Flanges 366 are generally located at the center of gravity of conveyor 192. The conveyor 192 is suspended from the swivel arm 350 and is free to rotate around the central axis of the pin 364 and the central axis of the pin 360.

The lift arm assembly 310 is configured for horizontal rotational movement around the central axis of the shaft 298. The lift arm assembly 310 is rotated by a swing actuator 380, such as a hydraulic actuator or hydraulic cylinder for example. The swing actuator 380 has a rod 382 connected to an elongated rack 384 having teeth 386 which engage the teeth 306 of the sprocket 300. Actuation of the swing actuator 380 rotates the sprocket 300 which rotates the lift arm assembly 310 around the central axis of the shaft 298.

FIG. 12 is a schematic of an illustrative seed tender control system 400 including an electronic control system 402 and a hydraulic control system 420. The electronic control system 402 includes an electronic control unit 404, an electronic control device 406, a data storage device 408, a fail-safe switch 410, and a transmitter/receiver 412. The electronic control unit 404 is configured to receive signals from a sensor system which includes sensors, switches, and other components of the seed tender 100. The electronic control unit 404 also receives inputs through control devices, such as the electronic control device 406. The electronic control device 406 may be wired to the electronic control unit 404 or may communicate wirelessly with the electronic control unit 404 through the transmitter/receiver 412. The electronic control device 406 may be configured to control various features and functions of the seed tender 100. The data storage device 408 is connected to the electronic control unit 404 and is configured to store data and control instructions, for example. In some embodiments, the data storage device 408 may be integrated into electronic control unit 404. The electronic control unit 404 receives input signals from the sensor system which includes the load cells 126, sensor 260, and switches 262, 264, 266, 268.

The fail-safe switch 410 may be mounted on the handle 248, see FIG. 1, to protect personnel operating and in the general vicinity of the seed tender 100 and/or prevent equipment damage. The fail-safe switch 410 is activated when the handle 248 is grasped by an operator and deactivated when the operator releases the handle 248. At least some of the functions of the seed tender 100 described herein will not operate if the fail-safe switch 410 is not activated. In this illustrative embodiment, the fail-safe switch 410 is electrically coupled to the electronic control unit 404. In other embodiments, the fail-safe switch 410 may be electrically coupled between the sensor 260 and the electronic control unit 404. In alternative embodiments, the fail-safe switch 410 may be electrically coupled between the switches 262, 264, 266, 268 and the electronic control unit 404.

The hydraulic control system 420 includes a hydraulic pump 422, a hydraulic fluid reservoir 424, and electrically actuated control valves 426, 428, 430, 432. The hydraulic control system 420 also includes and selectively sends pressurized hydraulic fluid to the front and rear gate actuators 166, 168, lift arm actuator 330, and swing actuator 380.

Often, transfer element and/or discharge spout directional controls may be dependent on the location of the control unit and/or operator. For example, a directional control unit may include “move right” and “move left” control buttons to control the movement of a transfer element and/or discharge spout, but right and left from the perspective of an operator are dependent on where the operator is standing in relation to the transfer element and/or discharge spout. Moving the conveyor 192 and/or discharge spout 210 in the wrong direction could cause injury and waste time. As disclosed herein, the control of the movement of the conveyor 192 and/or discharge spout 210 is not affected by the location of the operator relative to the conveyor 192 or the discharge spout 210 and is intuitive to an operator.

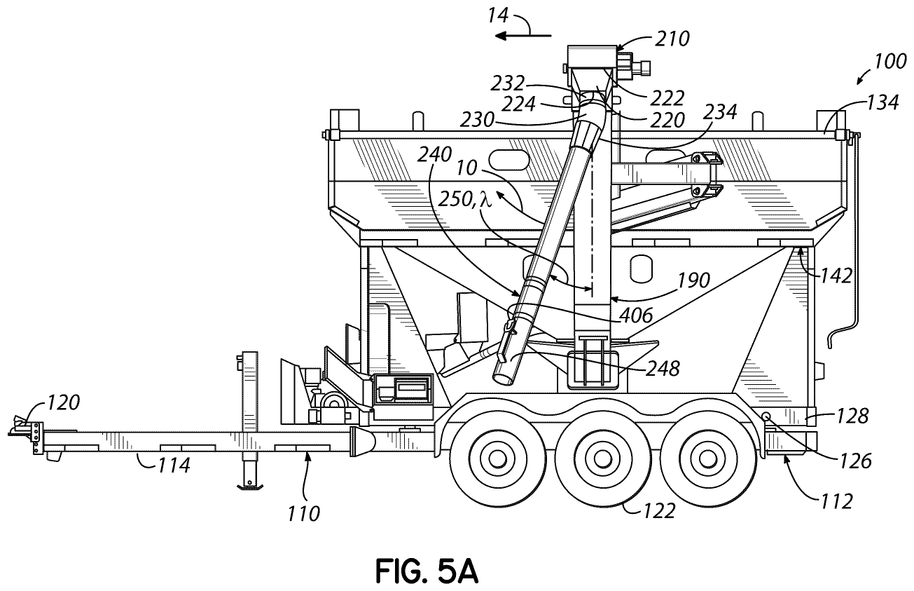

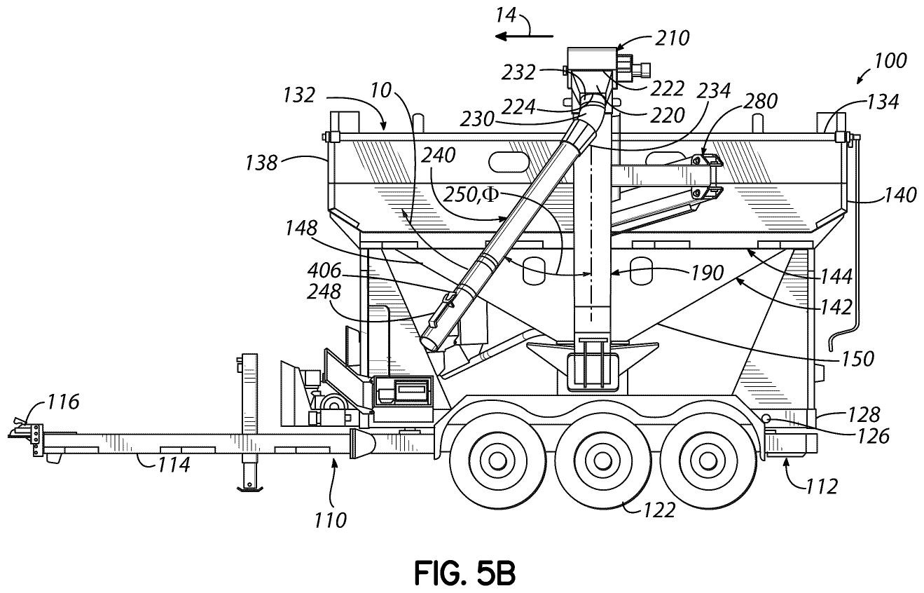

FIG. 4 shows the discharge portion 240 of the discharge spout 210 oriented generally downward due to gravity in a vertical or neutral orientation. FIG. 5A shows the discharge portion 240 angled in a first direction in a first orientation at a first inclination angle A, and FIG. 5B shows the discharge portion 240 angled in the first direction, indicated by arrow 10, in a second orientation at a second inclination angle ¢. The second inclination angle @ is greater than first inclination angle A. FIG. 6A shows the discharge portion 240 angled in a second direction, indicated by arrow 12, in a third orientation at the first inclination angle A, and FIG. 6B shows the discharge portion 240 angled in the second direction in a fourth orientation at the second inclination angle ¢. Moving the discharge portion 240 in the first and second directions causes the steerable or flexible portion 230 to bend or flex. The inclination angle 250 is 0° when the discharge portion 240 is in the neutral orientation. As the inclination angle 250 of the discharge portion 240 changes, the sensor 260 is activated and sends a signal, such as an analog signal for example, to the electronic control unit 404.

Referring to FIGS. 4, 5A, 6A, and 12, in this illustrative embodiment, with the fail-safe switch 410 activated, moving the discharge portion 240 of the discharge spout 210 in the first direction, as shown by arrow 10 in FIG. 5A, activates the sensor 260 which sends a signal to the electronic control unit 404. The electronic control unit 404 sends a signal to the swing control valve 432 which selectively sends hydraulic fluid to the swing actuator 380, thereby actuating the swing actuator 380 and moving the discharge end 198 of the conveyor 192 and the discharge spout 210 in a first corresponding direction indicated by arrow 14. It should be understood that in this illustrative embodiment, the movement in the first corresponding direction indicated by arrow 14 is generally in the same direction as the movement in the first direction indicated by arrow 10.

In alternative embodiments, moving the discharge portion 240 in the first direction activates a switch 262 thereby sending a signal to the electronic control unit 404. In some embodiments, the sensor 260 and/or the electronic control unit 404 may include a deadband such that when the discharge portion 240 is in the neutral orientation, moving the discharge portion 240 a small amount or at a slight angle will not cause the electronic control unit 404 to send a signal to the swing control valve 432. A deadband is often needed to prevent movement due to minor actions or movements that are not intended to be control inputs. The sensor 260 and/or the electronic control unit 404 may include a minimum threshold/angle (analog signal), indicating a deliberate input by an operator, to command movement of the transfer element 190. A deadband helps filter out swaying or oscillation of the transfer element 190 and it gives an operator a small window to move the discharge portion 240 about without activating movement of the transfer element 190.

With the fail-safe switch 410 activated, moving the discharge portion 240 of the discharge spout 210 in the second direction, as shown in FIG. 6A, activates the sensor 260 which sends a signal to the electronic control unit 404. In an alternative embodiment, moving the discharge portion 240 in the second direction activates the switch 264 thereby sending a signal to the electronic control unit 404. The electronic control unit 404 sends a signal to the swing control valve 432 which selectively sends hydraulic fluid to the swing actuator 380, thereby actuating the swing actuator 380 and moving the discharge end 198 of the conveyor 192 and the discharge spout 210 in a second corresponding direction indicated by arrow 16. It should be understood that in this illustrative embodiment, the movement in the second corresponding direction indicated by arrow 16 is generally in the same direction as the movement in the second direction indicated by arrow 12.

Returning or allowing the discharge portion 240 of the discharge spout 210 to return to the neutral orientation, as shown in FIG. 4, deactivates the sensor 260. Deactivating the fail-safe switch 410 also deactivates the sensor 260. When the sensor 260 is deactivated, the electronic control unit 404 sends a signal to the swing control valve 432 to stop the flow of hydraulic fluid to the swing actuator 380 which deenergizes the swing actuator 380. In some embodiments, when the discharge portion 240 is in the neutral orientation, and the fail-safe switch 410 is activated, the sensor 260 sends a signal to the electronic control unit 404 and the electronic control unit 404 sends a signal to the swing control valve 432 to stop the flow of hydraulic fluid to the swing actuator 380. In an alternative embodiment, returning or allowing the discharge portion 240 to return to the neutral orientation deactivates the switches 262, 264, and the electronic control unit 404 sends a signal to the swing control valve 432 to stop the flow of hydraulic fluid to the swing actuator 380. Moving the discharge portion 240 in a first or second direction to move the conveyor 192 and/or discharge spout 210 in the first or second direction respectively is intuitive to an operator. Returning or allowing the discharge portion 240 to return to the neutral orientation to stop movement of the conveyor 192 and/or discharge spout 210 is also intuitive to an operator.

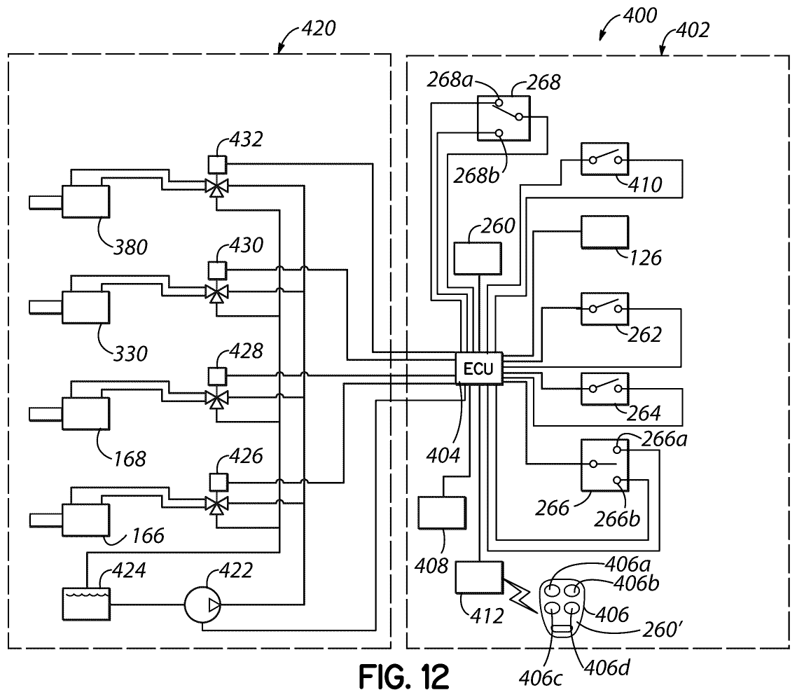

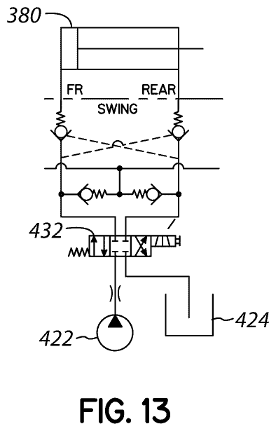

FIG. 13 is a simplified schematic of an illustrative hydraulic system showing a 4 way 3 position valve 432 for control of the swing actuator 380, also see FIG. 12. FIG. 14 illustrates control curves that may be used in conjunction with a proportional hydraulic position valve. The X-axis represents an inclination sensor analog output (4-20 mA signal in this example) and the Y-axis represents the percentage of the DC duty cycle output of each a coil associated with a proportional hydraulic position valve. In some embodiments, the swing control valve 432 may be a proportioning valve. The sensor 260 may be configured to send signals to the electronic control unit 404 based at least partly on the inclination angle 250 of the discharge portion 240 of the discharge spout 210.

Referring to FIGS. 4, 5A, 5B, 6A, 6B, 12, and 13, in this illustrative embodiment, with the fail-safe switch 410 activated, moving the discharge portion 240 in a first direction into a first orientation at the first inclination angle A, as shown in FIG. 5A, activates the sensor 260, such as a tilt sensor for example, which sends an analog signal to the electronic control unit 404. The electronic control unit 404 reads the analog signal from the sensor 260, scales the signal to be used in a quasi-linear scale for output, see FIG. 14, and sends a signal, such as a pulse-width modulation (PWM) signal for example, to the swing control valve 432. The swing control valve 432 selectively sends hydraulic fluid at a first volumetric flow rate to actuate the swing actuator 380, thereby moving the transfer element 190 in the first direction at a first velocity. With the fail-safe switch 410 activated, moving the discharge portion 240 in the first direction into a second orientation at the second inclination angle ¢, as shown in FIG. 5B, activates sensor 260 which sends a signal to the electronic control unit 404. The electronic control unit 404 sends a signal to the swing control valve 432 which selectively sends hydraulic fluid at a second volumetric flow rate to actuate the swing actuator 380, thereby moving the transfer element 190 in the first direction at a second velocity. The second volumetric flow rate is greater than the first volumetric flow rate and the second velocity is greater than the first velocity. The farther an operator moves the discharge portion 240 in the first direction, thereby increasing the inclination angle 250, the greater the volumetric flow rate of the hydraulic fluid the swing control valve 432 sends to the swing actuator 380 and the faster the swing actuator 380 moves the transfer element 190 in the first direction. In an alternative embodiment, the switch 262 includes a plurality of contacts, and moving the discharge portion 240 in the first direction into the first orientation activates a first pair of contacts in the switch 262 thereby sending a signal to the electronic control unit 404. Moving the discharge portion 240 in the first direction into the second orientation activates a second pair of contacts in switch 262 which sends a signal to the electronic control unit 404.

With the fail-safe switch 410 activated, moving the discharge portion 240 of the discharge spout 210 in a second direction into a third orientation at the first inclination angle A, as shown in FIG. 6A, activates the sensor 260 which sends a signal to the electronic control unit 404. The electronic control unit 404 sends a signal to the swing control valve 432 which selectively sends hydraulic fluid at a first volumetric flow rate to actuate the swing actuator 380, thereby moving the transfer element 190 in the second direction at the first velocity. With the fail-safe switch 410 activated, moving the discharge portion 240 in the second direction into a fourth orientation at the second inclination angle @, as shown in FIG. 6B, activates sensor 260 which sends a signal to the electronic control unit 404. The electronic control unit 404 sends a signal to the swing control valve 432 which selectively sends hydraulic fluid at a second volumetric flow rate to actuate the swing actuator 380 thereby moving the transfer element 190 in the second direction at the second velocity. The farther an operator moves the discharge portion 240 in the second direction, thereby increasing the inclination angle 250, the greater the volumetric flow rate of the hydraulic fluid the swing control valve 432 sends to the swing actuator 380 and the faster the swing actuator 380 moves the transfer element 190 in the second direction. In an alternative embodiment, the switch 264 includes a plurality of contacts, and moving the discharge portion 240 in the second direction into the third orientation activates a first pair of contacts in the switch 264 thereby sending a signal to the electronic control unit 404. Moving the discharge portion 240 in the second direction into the fourth orientation activates a second pair of contacts in the switch 264 thereby sending a signal to the electronic control unit 404.

Referring to FIGS. 1, 10, and 12, in this illustrative embodiment, the transfer element 190, and specifically, the discharge end 198 of the conveyor 192 and the discharge spout 210 may be raised or lowered. In this illustrative embodiment, the switch 266 is a three-way switch. For clarity, in this illustrative example, a three-way switch incorporates two switches, two pairs on contacts, into a single assembly. The switch 266 is mounted on or near the handle 248 and is oriented so that actuating the switch 266 in an upward direction activates a first pair of contacts 266a and actuating the switch 266 in an downward direction activates a second pair of contacts 266b. The switch 266 may be biased such that when an operator is not actuating the switch 266 the switch 266 returns to a neutral or deactivated position. Activating the first pair of contacts 266a sends a signal to the electronic control unit 404 which sends a signal to the lift arm control valve 430 which selectively sends hydraulic fluid to actuate or extend the lift arm actuator 330. Extending the lift arm actuator 330 raises the discharge end 198 of the conveyor 192 and the discharge spout 210 in an upward direction indicated by arrow 18. Activating the second pair of contacts 266b sends a signal to the electronic control unit 404 which sends a signal to the lift arm control valve 430 which selectively sends hydraulic fluid to actuate or retract the lift arm actuator 330. Retracting the lift arm actuator 330 lowers the discharge end 198 of the conveyor 192 and the discharge spout 210 in a downward direction indicated by arrow 20. In some embodiments, the fail-safe switch 410 may need to be activated before an operator actuates the switch 266. Actuating the switch 266 in an upward direction to raise the discharge end 198 of the conveyor 192 and the discharge spout 210 is intuitive to an operator. Actuating the switch 266 in an downward direction to lower the discharge end 198 of the conveyor 192 and the discharge spout 210 is also intuitive to an operator.

Referring to FIGS. 1, 10, and 12, in some embodiments, the lift arm control valve 430 may be a proportioning valve. The switch 266 may be a five-way switch, for example. Actuating the switch 266 in an upward direction into a first position activates a first pair of contacts, thereby sending a signal to the electronic control unit 404. The switch 266 may be biased such that when an operator is not actuating the switch 266 the switch 266 returns to a neutral or deactivated position. In some embodiments, the fail-safe switch 410 may need to be activated before an operator actuates the switch 266. The electronic control unit 404 sends a signal to the lift arm control valve 430 which selectively sends hydraulic fluid to actuate or extend the lift arm actuator 330 at a first velocity. Extending the lift arm actuator 330 raises the discharge end 198 of the conveyor 192 and the discharge spout 210. Actuating the switch 266 in an upward direction into a second position activates a second pair of contacts, thereby sending a signal to the electronic control unit 404. The electronic control unit 404 sends a signal to the lift arm control valve 430 which selectively sends hydraulic fluid to actuate or extend the lift arm actuator 330 at a second velocity. In this example, the second velocity is greater than the first velocity.

Actuating the switch 266 in an downward direction into a third position activates a third pair of contacts, thereby sending a signal to the electronic control unit 404. The electronic control unit 404 sends a signal to the lift arm control valve 430 which selectively sends hydraulic fluid to actuate or retract the lift arm actuator 330 at a first velocity. Retracting the lift arm actuator 330 lowers the discharge end 198 of the conveyor 192 and the discharge spout 210. Actuating the switch 266 in an downward direction into a fourth position activates a fourth pair of contacts, thereby sending a signal to the electronic control unit 404. The electronic control unit 404 sends a signal to the lift arm control valve 430 which selectively sends hydraulic fluid to actuate or retract the lift arm actuator 330 at a second velocity.

Actuating the switch 266 in an upward direction to a first position to raise the discharge end 198 of the conveyor 192 and the discharge spout 210 at a first velocity and to a second position to raise the discharge end 198 of the conveyor 192 and the discharge spout 210 at a second velocity is intuitive to an operator. Actuating the switch 266 in an downward direction to a third position to lower the discharge end 198 of the conveyor 192 and the discharge spout 210 at a first velocity and to a fourth position to lower the discharge end 198 of the conveyor 192 and the discharge spout 210 at a second velocity is also intuitive to an operator.

Referring to FIGS. 1, 9, and 12, in alternative embodiments, a switch 268 may be mounted on or near the handle 248 so the operator may activate the switch 268 while holding the handle to control the horizontal movement of the discharge spout 210. The switch 268 may be a three-way switch, for example. Actuating the switch 268 in a first direction activates a first pair of contacts 268a and actuating the switch 268 in a second direction activates a second pair of contacts 268b. The switch 268 may be biased such that when an operator is not actuating the switch 268 the switch 268 returns to a neutral or deactivated position. Activating the first pair of contacts 268a sends a signal to the electronic control unit 404 which sends a signal to the swing control valve 432. The swing control valve 432 selectively sends hydraulic fluid to the swing actuator 380 to actuate the swing actuator 380, thereby moving the transfer element 190 in the first direction. Activating the second pair of contacts 268b sends a signal to the electronic control unit 404 which sends a signal to the swing control valve 432. The swing control valve 432 selectively sends hydraulic fluid to the swing actuator 380 to actuate the swing actuator 380, thereby moving the transfer element 190 in the second direction. In some embodiments, the fail-safe switch 410 may need to be activated before an operator actuates the switch 268. Actuating the switch 268 in a first or second direction to move the transfer element 190 in the first or second direction respectively is intuitive to an operator.

In some embodiments, the telescoping element 242 may include one or more sensors and/or switches mounted on and/or coupled to the telescoping element 242 and configured to detect or be activated when the lower telescoping portion 246 moves relative to the upper telescoping portion 244 or other portions of the discharge spout 210. For example, sensors and/or switches may be configured to send a signal to the electronic control unit 404 when the lower telescoping portion 246 is moved up or down relative to other portions of the discharge spout 210. Alternatively, sensors and/or switches may be configured to send a signal to the electronic control unit 404 when the lower telescoping portion 246 is rotated around the upper telescoping portion 244, for example.

Referring to FIGS. 1, 7, 8, 8A, and 12, the electronic control device 406 may include, for example, toggle or trigger switches, pushbuttons, joysticks, touchpads, displays and/or any other input device configured to enable an operator to control the various features and functions of the seed tender 100. In some embodiments, the discharge spout 210 may include a bracket or holder located adjacent to the handle 248 and configured to receive the electronic control device 406. In some embodiments, an operator may use the electronic control device 406 to send a control signal to the electronic control unit 404 to open and close the front and rear gates 162, 164. The electronic control unit 404 sends a signal to the front and rear gate control valves 426, 428 which selectively send hydraulic fluid to actuate the front and rear gate actuators 166, 168. In some embodiments, an operator may use the electronic control device 406 to energize and de-energize the gas engine and/or pump 422. In some embodiments, an operator may use the electronic control device 406 to energize and de-energize the conveyor 192 to control the dispensing of seed. In some embodiments, the seed tender 100 may include an auto dispense function wherein a pre-set weight or volume of seed is dispensed when the auto dispense function is activated. In some embodiments, an operator may use the electronic control device 406 to activate the auto dispense function.

One or more switches may be mounted on or near the handle 248 enabling an operator to control the various features and functions of the seed tender 100. One or more switches mounted on or near the handle 248 may enable an operator to control the various features and functions of the seed tender 100 without the electronic control device 406. For example, in some embodiments, a switch may be mounted on or near the handle 248 enabling an operator to energize and de-energize the pump 422. In some embodiments, a switch may be mounted on or near the handle 248 enabling an operator to energize and de-energize the conveyor 192 to control the dispensing of seed. In some embodiments, a switch may be mounted on or near the handle 248 enabling an operator to activate an auto dispense function.

Referring to FIGS. 5A, 5B, 6A, and 6B, moving the discharge portion 240 of the discharge spout 210 in a first or second direction to move the transfer element 190 in the first or second direction respectively is intuitive to an operator. Moving the discharge portion 240 farther in a first or second direction to move the transfer element 190 faster in the first or second direction respectively is also intuitive to an operator. As the operator pulls the discharge portion 240 laterally, the transfer element 190 will move in the direction the operator pulls the discharge portion 240 until the discharge portion 240 is perpendicular to the ground, at which point the transfer element 190 will stop moving. Since the operator is required to swing the discharge portion 240 along the length of an implement, such as a planter for example, the use of this conveyor positioning system makes this function intuitive and allows the operator to keep their eyes on the equipment versus looking down at a remote control, for example. Furthermore, when paired with an auto dispense feature, the conveyor positioning system allows the operator to move the transfer element 190 along the entire width of a seed drill or planter without removing their thumb from the auto dispense button of the remote. This allows the operator to complete planter filling operations without looking at the remote.

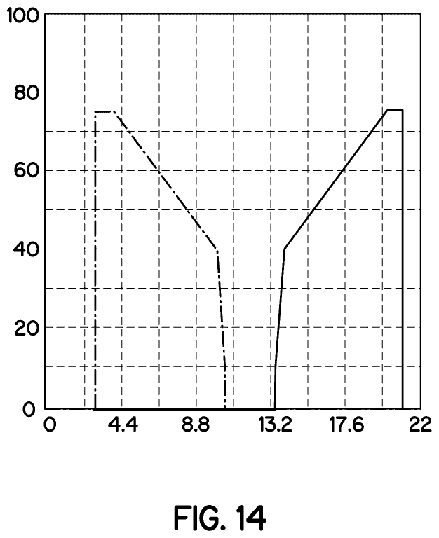

FIGS. 15, 16, and 17 are perspective views of an alternative illustrative seed tender 500. Generally, the seed tender 500 is similar in construction and/or operation to the seed tender 100 described herein. Any feature of the seed tender 500 may be used, in various other exemplary embodiments according to the present disclosure. For brevity, the following description minimizes redundant description and focuses on the differences between the seed tender 500 and the seed tender 100 described herein.

The illustrative seed tender 500 includes a chassis 510, a container 530, a transfer element 590, and a swing arm 680. The chassis 510 includes a frame 512 having longitudinally extending frame members converging to form a tongue 514 having a hitch 516 at the front of the frame 512. The chassis 510 includes one or more pairs of wheels 122 or tracks. A set of load cells 126 are mounted to the top of the chassis 510 and a container support frame 528 is mounted to and supported by the load cells 126.

In this illustrative embodiment, the container 530 includes an open top and generally rectangular upper portion 532. The upper portion 532 includes opposed upper left and right side walls 534, 536 connected by an upper front wall 538 and an upper rear wall 540. The container 530 also includes a sloped lower portion 542 including sloped lower left and right side walls 544, 546 connected by a sloped lower front wall 548 and a sloped lower rear wall 550. The upper left and right side walls 534, 536 are respectively coupled to the lower left and right side walls 544, 546. The upper front and rear walls 538, 540 are respectively coupled to the lower front and rear walls 548,550.

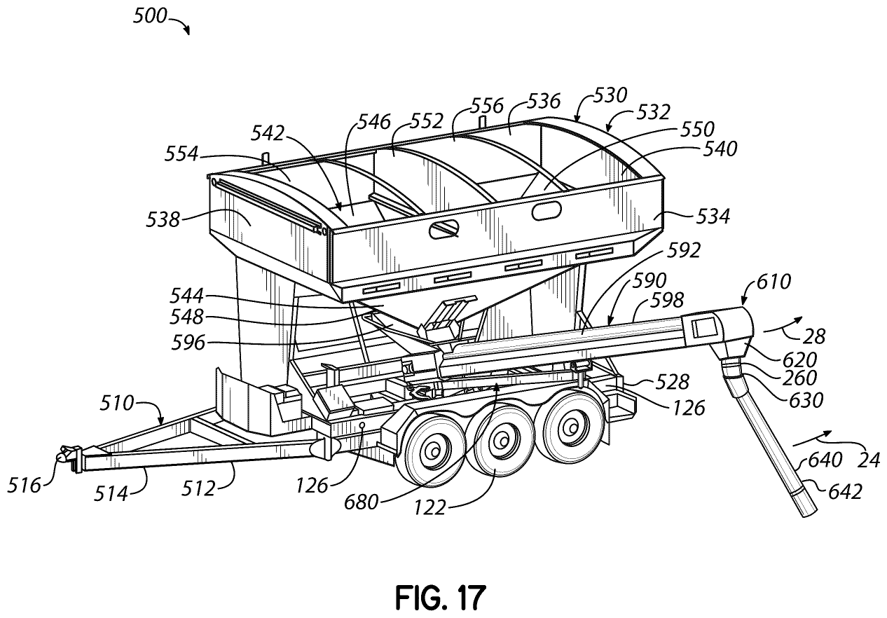

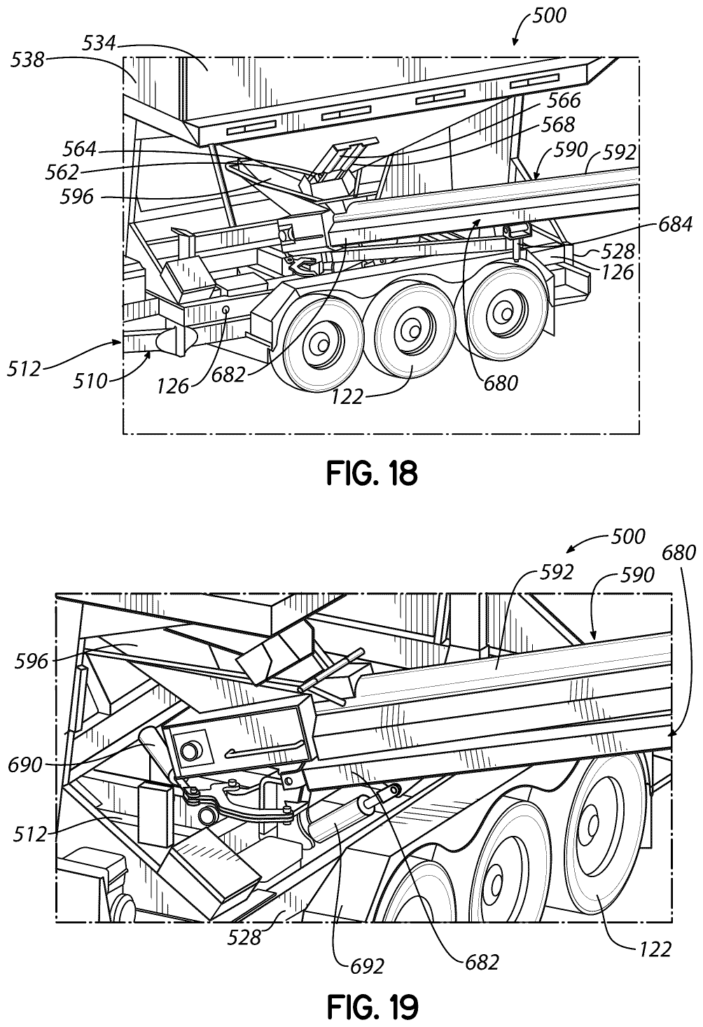

FIGS. 18 and 19 are detailed views of the lower portion of the container 530 and the inlet end of the transfer element 590. Referring to FIGS. 15 and 18, the container 530 also has a dividing wall 552 which is secured to the upper left and right side walls 534, 536 and the sloped lower left and right side walls 544, 546 to define a front seed chamber 554 and a rear seed chamber 556. The front and rear seed chambers 554, 556 have respective front and rear bottom discharge outlets which may be selectively opened and closed by respective front and rear sliding gates 562, 564. The front and rear gates 562, 564 are selectively opened and closed by respective front and rear gate actuators 566, 568.

In this illustrative embodiment, transfer element 590 includes a conveyor 592 and a discharge spout 610. The conveyor 592 has a hopper 596 at the receiving end portion of the conveyor 592 and the discharge spout 610 is mounted at the discharge end 598 of the conveyor 592. The discharge spout 610 includes a transition portion 620, a steerable or flexible portion 630, and a discharge portion 640. The discharge portion 640 includes an extendable portion or telescoping element 642. The discharge portion 640 may include one or more handles configured to allow an operator to move or position at least a portion of the discharge spout 610, such as the lower telescoping portion 646, for example.

FIGS. 15, 16, and 17 show the seed tender 500 configured for unloading, where the transfer element 590 is positioned to unload seed from the container 530 into a receiving container, such as a seed bin of a planter, for example. Seed is discharged from the front and/or rear chamber 554, 556 into the hopper 596 of the transfer element 590 and the seed is carried by the transfer element 590 to the discharge spout 610 where the seed is discharged.

The discharge spout 610 includes one or more sensors and/or switches that are activated when an operator moves at least a portion of the discharge spout 610. In this illustrative embodiment, the discharge spout 610 includes an inclination or tilt sensor 260, such as an inclinometer, mounted on or coupled to the steerable or flexible portion 630 and/or the discharge portion 640. The sensor 260 is configured to detect when the discharge portion 640 moves relative to the transition portion 620. When activated, the sensor 260 transmits an analog signal to an electronic control unit 404. In other embodiments, the sensor 260 may be mounted on or coupled to other portions of the discharge spout 610. In alternative embodiments, the discharge spout 610 may include one or more switches 262, 264, see FIG. 12, mounted on or coupled to the steerable or flexible portion 630 and/or the discharge portion 240. The switches 262, 264 may be configured to be activated when the discharge portion 640 moves relative to the transition portion 620. The switches 262, 264 may alternatively be mounted on or coupled to other portions of the discharge spout 610. The discharge spout 610 may include one or more controls and/or switches an operator may use to control various features of the seed tender 500.

Referring to FIGS. 15, 18, and 19, the seed tender 500 includes a swing arm 680 located under the transfer element 590 and configured to support the transfer element 590. The swing arm 680 includes a lower end portion 682 movably coupled to the frame 512 and an upper end portion 684 coupled to a mid-portion 594 of the transfer element 590. The swing arm 680 is configured to move around a generally vertical axis and a generally horizontal axis near the lower end portion 682. When the seed tender 500 is in an unload configuration, moving the swing arm 680 around the vertical axis moves the upper end portion 684, the discharge end 598 of the conveyor 592, and the discharge spout 610 of the transfer element 590 generally in an arc in the direction of arrows 26, 28. When the seed tender 500 is in an unload configuration, moving the swing arm 680 around the horizontal axis moves the upper end portion 684, the discharge end 598 of the conveyor 592, and the discharge spout 610 of the transfer element 590 up and down in the direction of arrows 30, 32. The seed tender 500 includes a swing actuator 690 configured to control the movement of the swing arm 680 around the vertical axis and a lift actuator 692 configured to control the movement of the swing arm 680 around the horizontal axis. In this illustrative embodiment, the actuators 690, 692 are hydraulic cylinders. In other embodiments, the actuators 690, 692 may be linear actuators, rotational actuators, motors, or any other type of actuator configured to move the swing arm 680 as described herein.

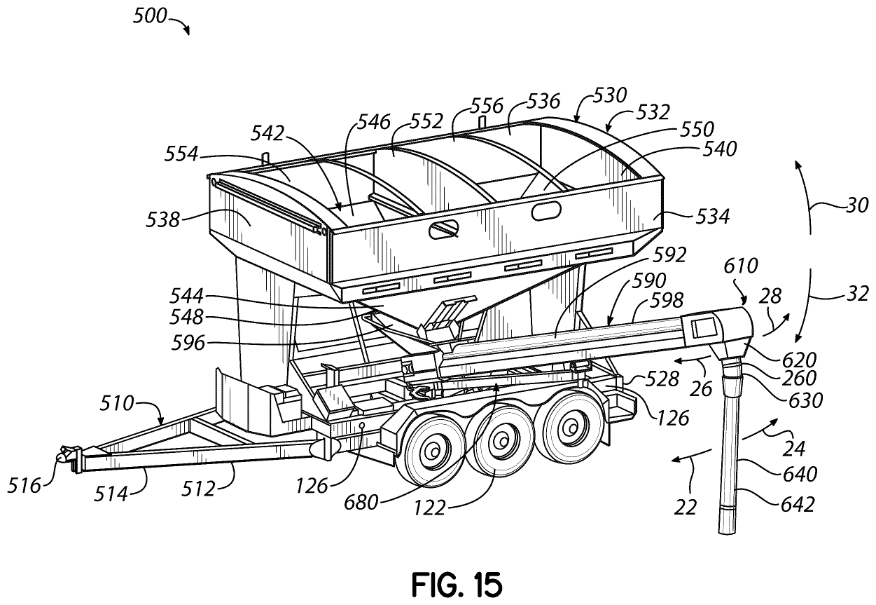

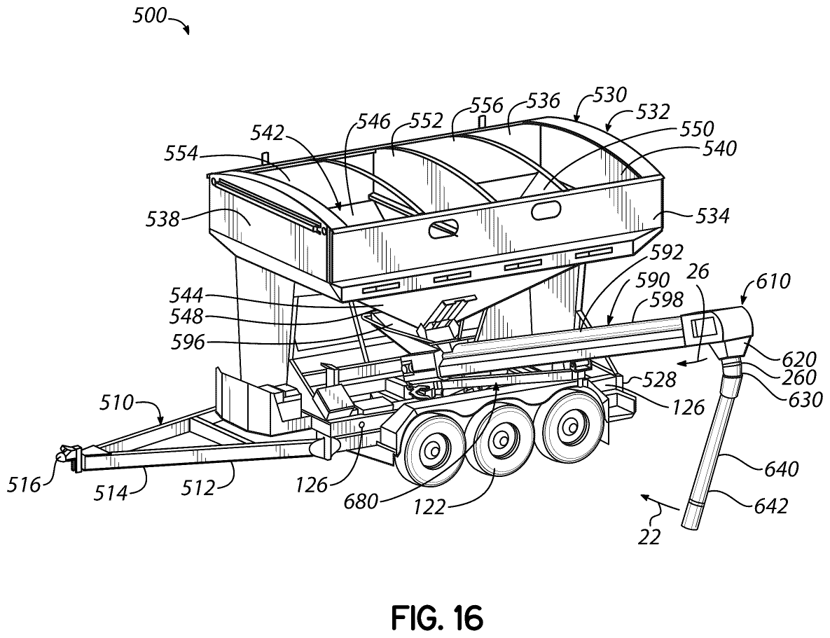

FIG. 15 shows the discharge portion 640 of the discharge spout 610 oriented generally downward due to gravity in a vertical or neutral orientation. FIG. 16 shows the discharge portion 640 angled in a first direction indicated by arrow 22. FIG. 17 shows the discharge portion 640 angled in a second direction, indicated by arrow 24. Moving the discharge portion 640 in the first and second directions indicated by arrows 22, 24 causes the steerable or flexible portion 630 to bend or flex. As the angle of the discharge portion 640 changes, the sensor 260 is activated and sends a signal, such as an analog signal for example, to the electronic control unit 404, see FIG. 12.

Referring to FIG. 12, in this illustrative embodiment, with the fail-safe switch 410 activated, moving the discharge portion 640 of the discharge spout 610 in the first direction, as shown by arrow 22 in FIG. 16, activates the sensor 260 which sends a signal to the electronic control unit 404. The electronic control unit 404 sends a signal to the swing control valve 432 which selectively sends hydraulic fluid to the swing actuator 690, thereby actuating the swing actuator 690 and moving the discharge end 598 of the of the conveyor 592 and the discharge spout 610 in a first corresponding direction indicated by arrow 26. In alternative embodiments, moving the discharge portion 640 in the first direction activates a switch 262 thereby sending a signal to the electronic control unit 404. It should be understood that in this illustrative embodiment, the movement in the first corresponding direction indicated by arrow 26 is generally in the same direction as the movement in the first direction indicated by arrow 22.

Referring again to FIG. 12, with the fail-safe switch 410 activated, moving the discharge portion 640 of the discharge spout 610 in the second direction, as shown in FIG. 17, activates the sensor 260 which sends a signal to the electronic control unit 404. In an alternative embodiment, moving the discharge portion 640 in the second direction activates the switch 264 thereby sending a signal to the electronic control unit 404. The electronic control unit 404 sends a signal to the swing control valve 432 which selectively sends hydraulic fluid to the swing actuator 690, thereby actuating the swing actuator 690 and moving the discharge end 598 of the of the conveyor 592 and the discharge spout 610 in the second corresponding direction indicated by arrow 28. It should be understood that in this illustrative embodiment, the movement in the second corresponding direction indicated by arrow 28 is generally in the same direction as the movement in the second direction indicated by arrow 24.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

What is claimed is:

1. A seed tender comprising:
a supplying container configured to hold seed;
a transfer element configured to transfer the seed from the supplying container to
a receiving container, the transfer element including:
a conveyor including a conveyor discharge end portion, and
a discharge spout coupled to the conveyor discharge end portion and configured to direct the seed into the receiving container;
a sensor system associated with the discharge spout; and
an actuator configured to control the movement of the transfer element;
wherein moving at least a portion of the discharge spout in a first direction activates the sensor system thereby energizing the actuator which moves the transfer element in a first corresponding direction associated with the first direction.

2. The seed tender of claim 1, wherein the sensor system is deactivated when the discharge spout is in a neutral orientation.

3. The seed tender of claim 1, further comprising a fail-safe switch;
wherein the actuator can only be energized when the fail-safe switch is activated.

4. The seed tender of claim 1, further comprising an electronic control unit configured to receive a signal from the sensor system and to energize the actuator based at least in part on the signal from the sensor system.

5. The seed tender of claim 1, wherein the discharge spout comprises a flexible portion and moving at least a portion of the discharge spout in the first direction causes the flexible portion to bend.

6. The seed tender of claim 1, wherein the sensor system comprises at least one of a switch, a tilt sensor, or an inclinometer.

7. The seed tender of claim 1, wherein moving at least a portion of the discharge spout in a second direction activates the sensor system thereby energizing the actuator which moves the transfer element in a second corresponding direction associated with the second direction.

8. The seed tender of claim 7, wherein moving at least a portion of the discharge spout in the first direction into a first orientation activates the sensor system thereby energizing the actuator which moves the transfer element in the first corresponding direction at a first velocity,
wherein moving at least a portion of the discharge spout in the first direction into a second orientation activates the sensor system thereby energizing the actuator which moves the transfer element in the first corresponding direction at a second velocity, the second velocity being greater than the first velocity,
wherein moving at least a portion of the discharge spout in the second direction into a third orientation activates the sensor system thereby energizing the actuator which moves the transfer element in the second corresponding direction at the first velocity, and
wherein moving at least a portion of the discharge spout in the second direction into a fourth orientation activates the sensor system thereby energizing the actuator which moves the transfer element in the second corresponding direction at the second velocity.

9. The seed tender of claim 7, wherein the discharge spout comprises a flexible portion and moving at least a portion of the discharge spout in the first direction and the second direction causes the flexible portion to bend.

10. The seed tender of claim 7, wherein the actuator is a first actuator, and the seed tender further comprises:
a second actuator configured to control the movement of the transfer element;
wherein moving at least a portion of the discharge spout in a third direction activates the sensor system thereby energizing the second actuator which moves the transfer element in a third corresponding direction associated with the third direction, and
wherein moving at least a portion of the discharge spout in a fourth direction activates the second sensor thereby energizing the second actuator which moves the transfer element in a fourth corresponding direction associated with the fourth direction.

11. The seed tender of claim 7, wherein the actuator is a first actuator, and the seed tender further comprises:
a first switch and a second switch; and
a second actuator configured to control the movement of the transfer element;
wherein activating the first switch thereby energizes the second actuator which moves the transfer element in a third direction, and
wherein activating the second switch thereby energizes the second actuator which moves the transfer element in a fourth direction.

12. A seed tender comprising:
a supplying container configured to hold seed;
a transfer element configured to transfer the seed from the supplying container to
a receiving container, the transfer element including:
a conveyor including a conveyor discharge end portion, and
a discharge spout coupled to the conveyor discharge end portion and configured to direct the seed into the receiving container;
a sensor system associated with the discharge spout;
a fail-safe switch;
an actuator configured to control the movement of the transfer element;
an electronic control unit configured to receive a signal from the sensor system and to energize the actuator based at least in part on the signal from the sensor system;
wherein the actuator can only be energized when the fail-safe switch is activated,
wherein moving at least a portion of the discharge spout in a first direction activates the sensor system thereby energizing the actuator which moves the transfer element in a first corresponding direction associated with the first direction,
wherein moving at least a portion of the discharge spout in a second direction activates the sensor system thereby energizing the actuator which moves the transfer element in a second corresponding direction associated with the second direction, and
wherein the sensor system is deactivated when the discharge spout is in a neutral orientation.

13. The seed tender of claim 12, wherein the discharge spout comprises a flexible portion and moving at least a portion of the discharge spout in the first direction and the second direction causes the flexible portion to bend.

14. The seed tender of claim 12, wherein the sensor system comprises at least one of a switch, a tilt sensor, or an inclinometer.

15. The seed tender of claim 12, wherein the actuator is a first actuator, and the seed tender further comprises:
a second actuator configured to control the movement of the transfer element;
wherein moving at least a portion of the discharge spout in a third direction activates the sensor system thereby energizing the second actuator which moves the transfer element in a third corresponding direction associated with the third direction, and
wherein moving at least a portion of the discharge spout in a fourth direction activates the sensor system thereby energizing the second actuator which moves the transfer element in a fourth corresponding direction associated with the fourth direction.

16. The seed tender of claim 12, wherein the actuator is a first actuator, and the seed tender further comprises:
a first switch associated with the discharge spout;
a second switch associated with the discharge spout; and
a second actuator configured to control the movement of the transfer element;
wherein activating the first switch thereby energizes the second actuator which moves the transfer element in a third direction, and
wherein activating the second switch thereby energizes the second actuator which moves the transfer element in a fourth direction.

17. The seed tender of claim 12, wherein moving at least a portion of the discharge spout in the first direction into a first orientation activates the sensor system thereby energizing the actuator which moves the transfer element in the first corresponding direction at a first velocity,
wherein moving at least a portion of the discharge spout in the first direction into a second orientation activates the sensor system thereby energizing the actuator which moves the transfer element in the first corresponding direction at a second velocity, the second velocity being greater than the first velocity,
wherein moving at least a portion of the discharge spout in the second direction into a third orientation activates the sensor system thereby energizing the actuator which moves the transfer element in the second corresponding direction at the first velocity, and
wherein moving at least a portion of the discharge spout in the second direction into a fourth orientation activates the sensor system thereby energizing the actuator which moves the transfer element in the second corresponding direction at the second velocity.

18. A method for transferring seed from a seed tender to a receiving container, the seed tender including a supplying container and a transfer element including a discharge spout and configured to transfer the seed from the supplying container to the receiving container, the method comprising:
detecting movement of at least a portion of the discharge spout in a first direction; and
energizing an actuator based at least in part on the detected movement of the discharge spout in the first direction to move the transfer element in a first corresponding direction associated with the first direction.

19. The method of claim 18, further comprising deenergizing the actuator when the discharge spout is in a neutral orientation.

20. The method of claim 18, further comprising energizing the actuator only when a fail-safe switch is activated.

21. The method of claim 18, further comprising:
detecting movement of at least a portion of the discharge spout in a second direction; and
energizing the actuator based at least in part on the detected movement of the discharge spout in the second direction to move the transfer element in a second corresponding direction associated with the second direction.

22. The method of claim 21, wherein the actuator is a first actuator, and the method further comprises:
detecting movement of at least a portion of the discharge spout in a third direction;
energizing a second actuator based at least in part on the detected movement of the discharge spout in the third direction to move the transfer element in a third corresponding direction associated with the third direction;
detecting movement of at least a portion of the discharge spout in a fourth direction; and
energizing the second actuator based at least in part on the detected movement of the discharge spout in the fourth direction to move the transfer element in a fourth corresponding direction associated with the fourth direction.

23. The method of claim 21, wherein the actuator is a first actuator, and the method further comprises:
detecting a first switch activation;
energizing a second actuator based at least in part on the detected switch activation to move the transfer element in a third direction;
detecting a second switch activation; and
energizing the second actuator based at least in part on the detected switch activation to move the transfer element in a fourth direction.

24. The method of claim 21, further comprising:
detecting at least a portion of the discharge spout in a first orientation;
energizing the actuator based at least in part on the detected portion of the discharge spout in the first orientation to move the transfer element in the first corresponding direction at a first velocity;
detecting at least a portion of the discharge spout in a second orientation;
energizing the actuator based at least in part on the detected portion of the discharge spout in the second orientation to move the transfer element in the first corresponding direction at a second velocity;
detecting at least a portion of the discharge spout in a third orientation;
energizing the actuator based at least in part on the detected portion of the discharge spout in the third orientation to move the transfer element in the second corresponding direction at the first velocity;
detecting at least a portion of the discharge spout in a fourth orientation; and
energizing the actuator based at least in part on the detected portion of the discharge spout in the fourth orientation to move the transfer element in the second corresponding direction at the second velocity;
wherein the second velocity is greater than the first velocity.
